(19) United States
(12) Patent Application Publication
(10) Pub. No.: US 2026/0052315 A1
(43) Pub. Date: Feb. 19, 2026

(54) VEHICULAR CABIN MONITORING SYSTEM WITH LIGHT CONTROL BASED ON OCCUPANT LOCATION

(71) Applicant: Magna Electronics Inc., Auburn Hills, MI (US)

(72) Inventors: Christian Euler, Aschaffenburg (DE); Zhiliang Chen, Ulm (DE); Nan Wang, Röthenbach An Der Pegnitz (DE); Haiquan Li, Rochester Hills, MI (US)

(21) Appl. No.: 19/370,954

(22) Filed: Oct. 28, 2025

Related U.S. Application Data
(63) Continuation-in-part of application No. 18/904,108, filed on Oct. 2, 2024.
(60) Provisional application No. 63/587,471, filed on Oct. 3, 2023.
(60) Provisional application No. 63/716,387, filed on Nov. 5, 2024.

(51) Int. Cl. H04N 23/74; B60Q 3/74; B60R 1/04; B60R 1/12; B60R 16/023; G06V 20/59; H04N 23/21; H04N 23/71; H04N 23/90

(52) U.S. Cl. CPC H04N 23/74; B60Q 3/74; B60R 1/04; B60R 1/1207; B60R 16/0231; H04N 23/21; H04N 23/71; H04N 23/90; B60Q 2500/00; B60R 2001/1253; G06V 20/59

(57) ABSTRACT

A vehicular cabin monitoring system includes first and second cameras disposed respectively at first and second positions within an interior cabin of a vehicle and respectively viewing first and second regions. A light emitter is operable to emit near infrared light that illuminates the first region. Based on image data captured by the second camera, the system detects an occupant within the interior cabin and determines a distance between the occupant and the light emitter. Based on image data captured by the first camera, the system determines luminance of near infrared light within the first region. Responsive to determining that the luminance is greater than a threshold luminance, the system reduces intensity of the near infrared light. Based on the distance between the occupant and the light emitter being greater than a threshold distance, the threshold luminance is greater than when the distance is less than the threshold distance.

### CROSS REFERENCE TO RELATED APPLICATIONS

The present application claims the filing benefits of U.S. provisional patent application Ser. No. 63/716,387, filed Nov. 5, 2024, which is hereby incorporated herein by reference in its entirety. The present application is also a continuation-in-part of U.S. patent application Ser. No. 18/904,108, filed Oct. 2, 2024, which claims the filing benefits of U.S. provisional application Ser. No. 63/587,471, filed Oct. 3, 2023, which are hereby incorporated herein by reference in their entireties.

### FIELD OF THE INVENTION

The present invention relates generally to a vehicle cabin monitoring system for a vehicle and, more particularly, to a vehicle cabin monitoring system that utilizes one or more cameras at a vehicle.

### BACKGROUND OF THE INVENTION

Use of imaging sensors in vehicle imaging systems is common and known.

Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular cabin monitoring system includes a plurality of cameras disposed within a cabin of a vehicle equipped with the vehicular cabin monitoring system and viewing within an interior cabin of the vehicle. The cameras are operable to capture image data and each include an imager having a CMOS imaging array having at least one million photosensors arranged in rows and columns. For example, the system may include a driver monitoring camera viewing a driver region of the cabin of the vehicle, an occupant monitoring camera viewing an occupant or passenger region of the cabin of the vehicle, and a cabin monitoring camera viewing at least the driver region of the cabin of the vehicle and the occupant region of the cabin of the vehicle. The system includes an electronic control unit (ECU) with electronic circuitry and associated software. The electronic circuitry includes an image processor operable to process image data captured by the cameras. Image data captured by the cameras is transferred to and is processed at the ECU. The system includes a light emitter operable to emit nonvisible light. Nonvisible light emitted by the light emitter, when electrically operated to emit nonvisible light, illuminates at least a portion of the interior cabin that is viewed by at least one of the cameras (e.g., the driver monitoring camera and/or the occupant monitoring camera). The cabin monitoring camera may at least partially view the driver monitoring camera, the occupant monitoring camera and/or the light emitter. The vehicular cabin monitoring system determines a distance between an occupant of the vehicle and the light emitter via processing of image data captured by the occupant monitoring system. The vehicular cabin monitoring system, with the light emitter electrically operated to emit nonvisible light, and via processing at the ECU of image data captured by one of the driver monitoring or occupant monitoring cameras and transferred to the ECU, determines luminance of nonvisible light at a region of interest within the illuminated portion of the interior cabin that is viewed by the camera. The vehicular cabin monitoring system, responsive to determining that the luminance of nonvisible light at the region of interest is greater than a threshold luminance, reduces intensity of nonvisible light emitted by the light emitter. Based on the determined distance between the occupant of the vehicle and the light emitter being greater than a threshold distance, the threshold luminance is a first value. Based on the determined distance between the occupant of the vehicle and the light emitter being less than the threshold distance, the threshold luminance is a second value that is less than the first value.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a cabin monitoring system that incorporates one or more cameras;

FIGS. 2A-2F are schematic views of different potential scenarios where an occupant of a vehicle is within a minimum distance of a camera or light emitting diode (LED) of a cabin monitoring system;

FIG. 3 shows images derived from frames of image data captured by a camera of a vehicular cabin monitoring system with an occupant of the vehicle within a minimum distance of the camera;

FIG. 4 is a state diagram of the cabin monitoring system of FIG. 1;

FIG. 5 is a plan view of fields of illumination of LEDs of a cabin monitoring system;

FIGS. 6A-6C show images derived from frames of image data captured by a camera annotated by a region of interest;

FIG. 7 shows another image derived from a frame of image data captured by a camera annotated by a region of interest;

FIG. 8 is a graph of the exposure level of photosensors or pixels of a camera within a region of interest with an object at varying distances from the camera;

FIG. 9 is a schematic view of the interior cabin of the vehicle, with a driver monitoring camera, an occupant monitoring camera and a cabin monitoring camera viewing respective regions of the interior cabin of the vehicle;

FIG. 10 is a schematic view of the cabin monitoring system;

FIG. 11 is a flow diagram of an example method of operations for adjusting operation of the LEDs based on exposure level of image data captured by the driver-monitoring camera and based on determined proximity of the driver and/or occupants to the LEDs based on image data captured by the cabin monitoring camera; and

FIGS. 12A-12C show images derived from frames of image data captured by the camera annotated by regions of interest.

### DESCRIPTION OF THE PREFERRED EMBODIMENTS

A vehicular cabin monitoring system operates to capture images interior of the vehicle and may process the captured image data to detect objects within the vehicle, such as to monitor an attentiveness of the driver of the vehicle. The cabin monitoring system includes an image processor or image processing system that is operable to receive image data from one or more cameras. The system includes one or more illumination sources, such as light emitting diodes (LEDs) or vertical-cavity surface-emitting lasers (VCSEL), that emit light to illuminate the field of view of the camera(s) in low light conditions.

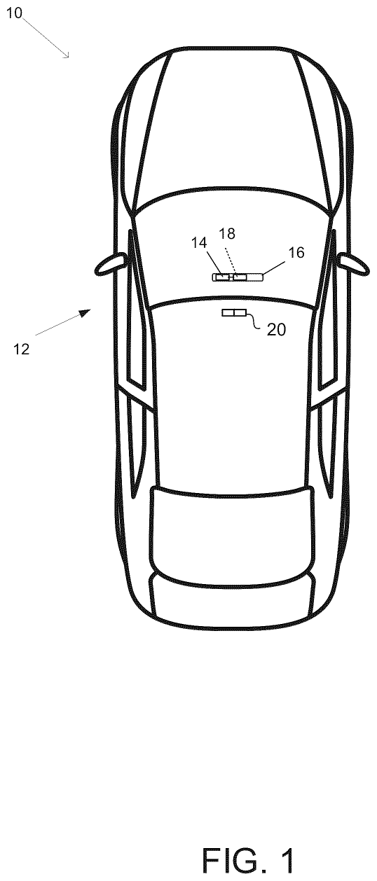

Referring now to the drawings and the illustrative embodiments depicted therein, a vehicle 10 includes a cabin monitoring system 12 that includes at least one interior viewing imaging sensor or camera, such as a camera 14 disposed at a rearview mirror assembly 16 of the vehicle (and the system may optionally include one or more cameras at other locations within the vehicle, such as at a windshield of the vehicle, at a headliner of the vehicle, at an instrument panel of the vehicle, etc.), which captures images interior of the vehicle, with the camera having a lens for focusing images at or onto an imaging array or imaging plane or imager of the camera (FIG. 1). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like (although shown in FIG. 1 as being part of or incorporated in or at an interior rearview mirror assembly 16 of the vehicle, the ECU may be disposed elsewhere at or in the vehicle). The data transfer or signal communication from the camera to the ECU may comprise any suitable data or communication link, such as a vehicle network bus or the like of the equipped vehicle.

The cabin monitoring system 12 includes one or more light emitters, such as two or more LEDs 20 (or other light sources such as VCSELs) that are operable to emit light to illuminate the cabin of the vehicle for the camera 14 during low light conditions. For example, a first LED or light source 20 illuminates the cabin for a driver monitoring function of the cabin monitoring system and a second LED or light source 20 illuminates the cabin for an occupant monitoring function of the cabin monitoring system. The LEDs 20 may emit visible light or nonvisible light, such as infrared (IR) light or near-IR light. For example, the cabin monitoring system may include a light emitter (that includes one or more LEDs or other suitable illumination source) that, when electrically operated, emits near infrared light, and the camera may be sensitive to near infrared light, with the frame capture rate of the camera at least in part corresponding to the pulse rate of the near infrared light emitter. Although discussed herein as including LEDs 20 that emit IR or near-IR light, it should be understood that the cabin monitoring system 12 may utilize any suitable light source configured to emit IR or near-IR light, such as VCSELs, microLEDs, organic LEDs (OLEDs), and the like. The light emitter may be located at any location within the cabin of the vehicle, such as at an interior mirror assembly, at a headliner/roof, at a central console, etc.

Cabin monitoring systems such as driver monitoring systems (DMS) and occupant monitoring systems (OMS) are vehicle safety systems that monitor and assess drivers or other occupants of a vehicle for any number of purposes. For example, a DMS may estimate or predict an alertness or drowsiness of a driver and take action (e.g., generate a warning) when the driver appears too drowsy to drive safely. As another example, an OMS may monitor for the presence and health of any occupant of the vehicle, such as when a child is left behind in a vehicle. These vehicles often rely on infrared (IR) or near-IR light LEDs to illuminate the cabin with non-visible light during low light conditions. However, for safety concerns, it is not recommended for these LEDs to shine directly into human eyes (e.g., when the eye is near the LED) at high levels of power, even though the emitted light is not visible to the human. Prolonged exposure to high-intensity IR light can potentially cause damage to the eyes.

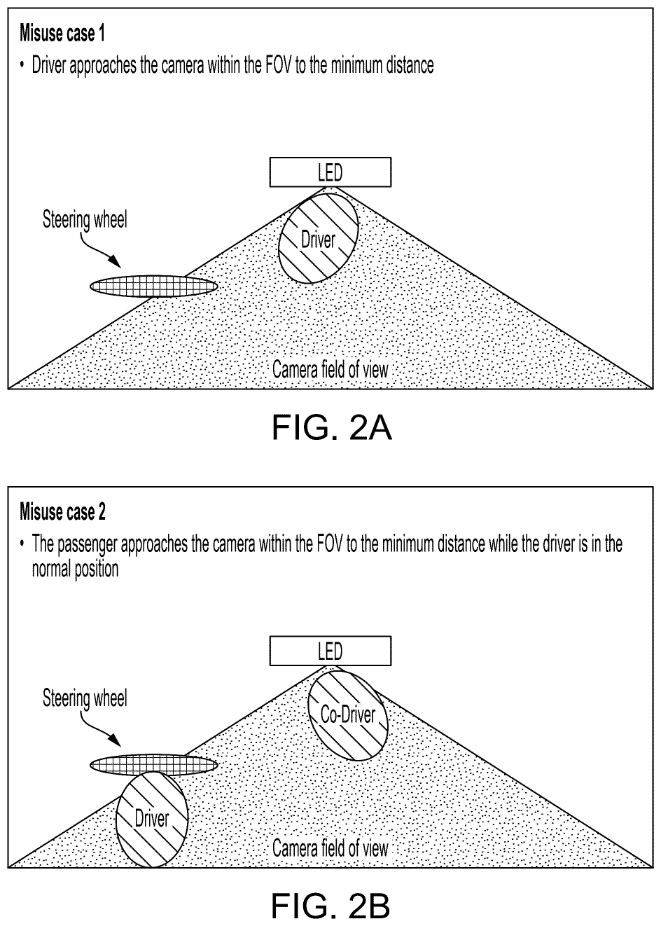

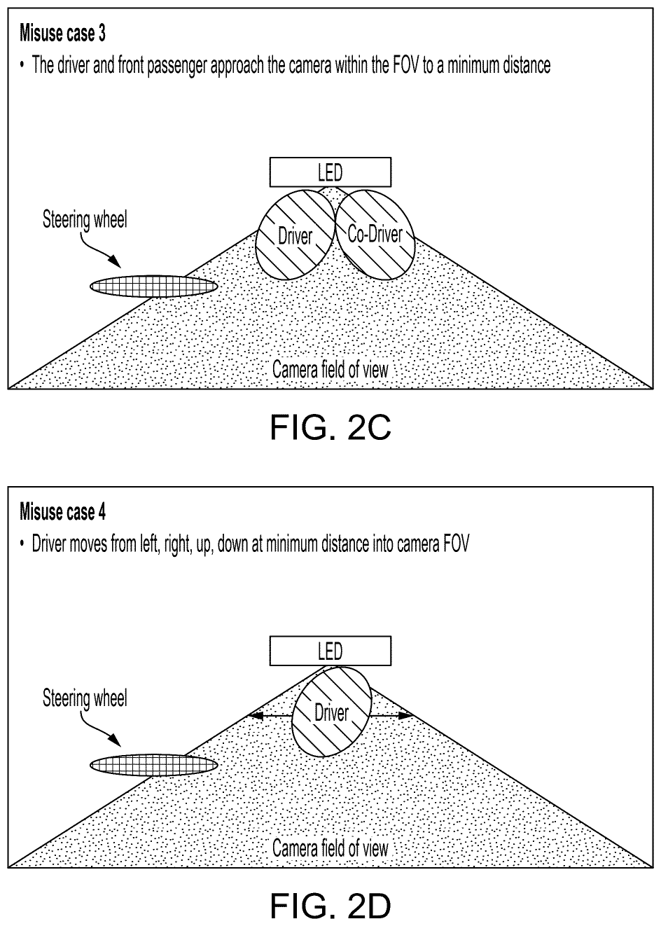

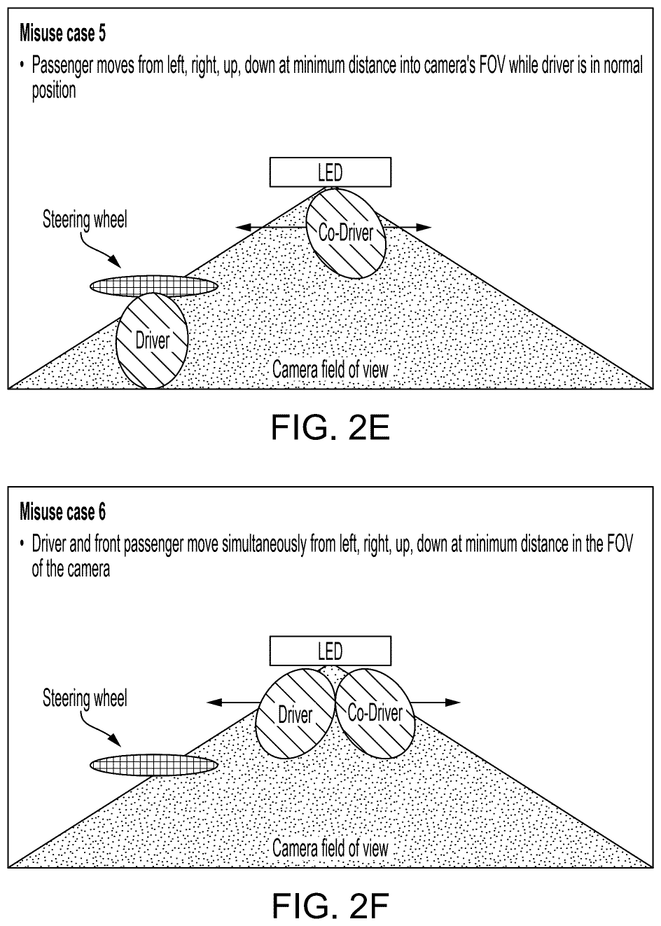

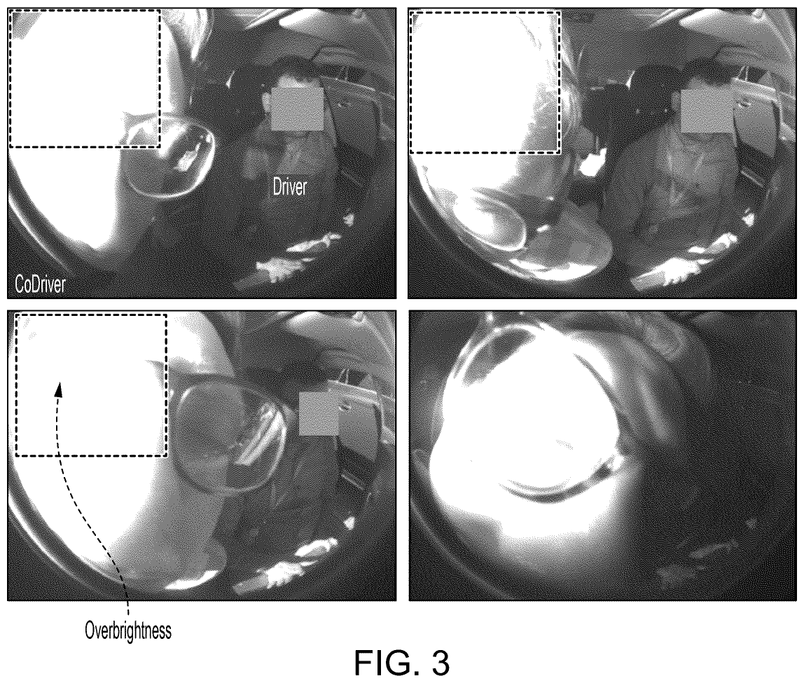

For example, as shown in FIGS. 2A-2F, several misuse cases can arise when a driver and/or an occupant of the vehicle position their head within a threshold distance of the IR source (e.g., one or more IR or near IR LEDs) where the eyes may be exposed to more intense IR light. For instance, as shown in FIG. 3, an occupant or co-driver (e.g., a driver's ed instructor that has a steering wheel or brake pedal) of the vehicle unwittingly receives direct exposure to the IR light when leaning forward toward the dashboard of the vehicle. Specifically, FIG. 3 illustrates the Misuse case 2 of FIG. 2B and the Misuse case 5of FIG. 2E. Conventional solutions to these misuse cases rely on blockage detection to mitigate safety concerns. For example, when the camera cannot properly detect a human, the camera raises a blockage status and then the LED radiance is reduced. However, this blockage solution can be unreliable as the blockage status can be caused by other issues such as a dirty lens, camera, a broken lens, etc.

Implementations herein are directed toward systems and methods for preventing eye damage for IR and near-IR LED illumination sources (such as for camera-based DMS and OMS). The implementations include a vehicular cabin monitoring system that determines when an occupant (e.g., a driver or passenger) of the vehicle approaches the illumination source and reduces the radiation power (i.e., the amount of IR light emitted) to levels safe for human eyes. For example, the system may process image data captured by a camera to determine the brightness of photosensors or pixels in a specific area of interest (which represents the luminance of the nonvisible light). If the brightness or luminance exceeds a certain threshold, the system reduces the amount of nonvisible light emitted by the LEDs.

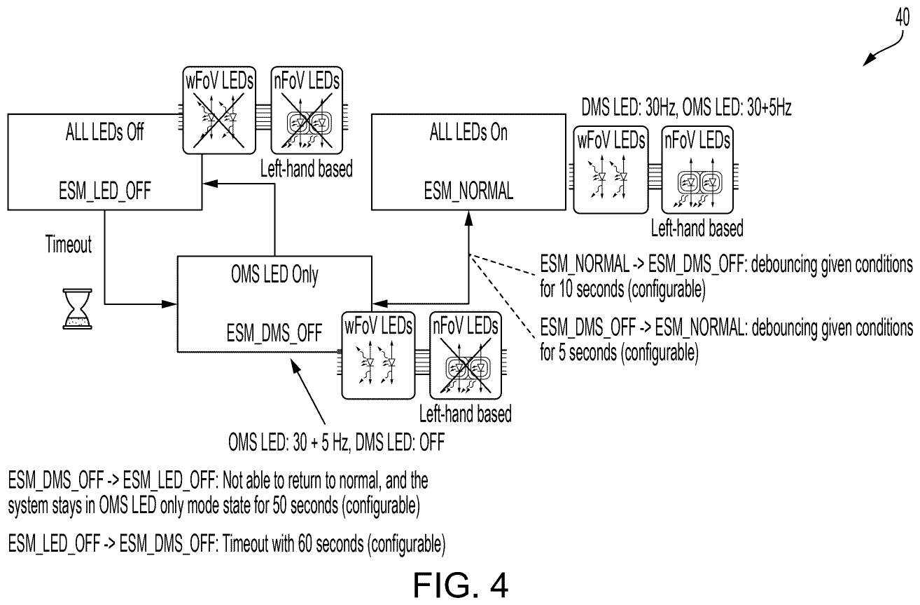

Referring now to FIG. 4, a state machine 40 for the vehicular cabin monitoring system 12 is illustrated. The vehicular cabin monitoring system has one or more DMS LEDs (or other illumination sources) for illuminating a driver of the vehicle and one or more OMS LEDs (or other illumination sources) for illuminating other occupants of the vehicle.

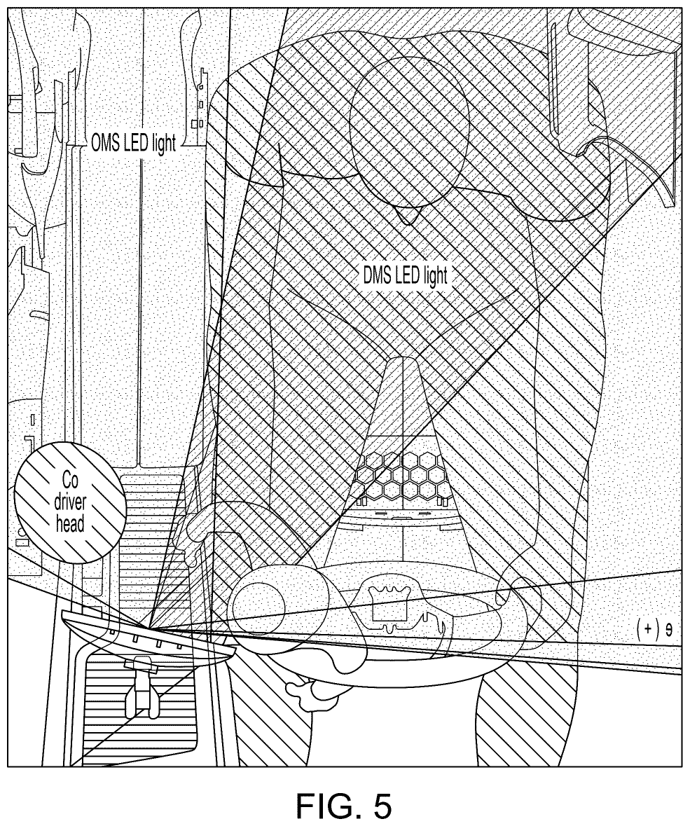

The OMS LED may provide a wide field of illumination while the DMS LED may provide a relatively narrower field of illumination (FIG. 5) compared to the OMS LED. The system may utilize aspects of the systems described in U.S. Pat. Nos. 11,827,153; 11,780,372 and/or 11,639,134, and/or International Publication No. WO 2023/220222, which are all hereby incorporated herein by reference in their entireties.

The state machine 40 in this example has three states: an ALL LEDs OFF state, an OMS LED Only state, and an ALL LEDs On state. Each of these states dictates the operational behavior of the LEDs within the vehicular cabin monitoring system. In the ALL LEDs On state, both the DMS LED(s) and the OMS LED(s) are enabled/pulsed at respective frequencies (e.g., 30 Hz). The frequencies may be the same for both the DMS LED and the OMS LED or the frequencies may be different for the DMS LED and the OMS LED. Optionally, the frequencies are the same but there is a phase shift between the OMS LED pulsing and the DMS LED pulsing (e.g., a 180-degree phase shift). This phase shift can help in reducing interference or achieving specific lighting effects. The ALL LEDs On state may be the default operational state (i.e., the state the system is in during nominal operation).

In the OMS LED Only state, the OMS LED(s) may be operational (i.e., pulsing at a defined frequency, such as at 30 Hz) and the DMS LED is off or inactive (i.e., does not pulse or emit light at all). Conversely, in the ALL LEDs Off state, neither the OMS LED nor the DMS LED pulse or emit light.

The state machine 40 may transition from the ALL LEDs On state (i.e., the normal or default state) to the OMS LED Only state when, as described in more detail below, the system determines that a human head/face is approaching the LEDs. For example, the system determines that a head is approaching one or both of the DMS and OMS LEDs. Upon making this determination, the system transitions to the OMS LED Only state and may turn off the DMS LED. In this OMS LED state, the system continues to monitor (such as continuously monitors) whether the head, particularly the eyes, is at risk from exposure to the OMS LED. If such a risk is detected, the system transitions to the ALL LEDs Off state, wherein both the DMS LED and the OMS LED are turned off to mitigate any potential harm.

In the ALL LEDs Off state, the system remains inactive for a configurable timeout period. This period can be set to various durations, such as at least 10 seconds, at least 30 seconds, at least 50 seconds and the like, depending on the specific requirements of the application. After this timeout period elapses, the system automatically transitions back to the OMS LED Only state. During this state, if the system detects a risk to the head or eyes from the OMS LED, it may transition back to the ALL LEDs Off state to ensure safety.

Alternatively, if during the OMS LED Only state the system determines that the risk is no longer present (indicating that the head has moved away from the LEDs), the state machine 40 may transition back to the ALL LEDs On state. This transition signifies a return to normal operation where all LEDs are active. The system's ability to dynamically transition between these states ensures that it can effectively manage and mitigate risks associated with human interaction with the LEDs while maintaining optimal functionality.

Optionally, the system determines whether a head is approaching the LEDs by determining the luminance of the nonvisible light within a region of interest of the captured image data. For example, the system determines whether a head is approaching the LEDs based on a distribution of brightness values for photosensors or pixels in frames of image data captured by the camera while the LEDs emit or radiate IR or near IR light. This determination process may involve analyzing the brightness values in predefined regions of interest (ROIs) within each captured image. The system determines whether the distribution of brightness values satisfies (e.g., exceeds) a threshold value for at least a threshold period of time. The threshold period of time may be defined as at least a certain time duration and/or a threshold number of sequential frames of image data. If the system determines that the brightness values satisfy this threshold condition, the system may adjust the amount of IR light emitted by the LEDs. For example, the system determines that the brightness in a given ROI exceeds a threshold value for at least one second (or any other threshold period of time), and, in response, reduces the amount of IR light emitted by the LEDs (e.g., by transitioning from the ALL LEDs On state to the OMS LED Only state). As another example, the system determines that the brightness in a given ROI is below a threshold value for at least one second, and, in response, increases the amount of IR light emitted by the LEDs (e.g., by transitioning from the OMS LED Only state to the ALL LEDs On state).

Optionally, the system determines the distribution of brightness within the ROI based on evaluating the percentage of photosensors or pixels within the ROI in one or more frames of image data that satisfy the threshold value (i.e., the quantity of photosensors or pixels overexposed or too bright within the ROI). For example, the system may decrease the amount of IR light emitted when over 70 percent of the photosensors or pixels within the ROI exceed the brightness threshold (i.e., are overexposed). As shown in FIG. 5, the system may first disable the narrow field of illumination provided by the DMS LED (i.e., by transitioning to the OMS LED Only state) and use the wider field of illumination provided by the OMS LED to continue to evaluate the risk to the occupants of the vehicle without use of the DMS LED.

When the system, while in the OMS LED Only state, determines that a risk continues to be present for an occupant of the vehicle (for example, the brightness of the ROI remains above the threshold level for another threshold period of time), the system may transition to the ALL LEDs Off state to disable all LEDs and eliminate the risk to the occupants of the vehicle. For example, if the system is in the OMS LED Only state for at least 10 seconds with the brightness within the ROI continuing to exceed a threshold (which may be the same threshold as the ALL LEDs On state or a different threshold), the system may automatically transition to the ALL LEDs Off state. The system may wait for a threshold period of time (e.g., a configurable timeout such as at least 20 seconds or at least 30 seconds, such as 50 seconds or 60 seconds or more, and the like) in the ALL LEDs Off state before transitioning back to the OMS LED Only state.

In this state, the system may again determine whether the risk to the occupants remains. If the risk remains, the system may return to the ALL LEDs Off state. If this risk is no longer present, such as when an occupant has moved away from the camera and/or LEDs, thereby reducing or eliminating the excessive brightness, the system may transition back to the ALL LEDs On state. In this state, all LEDs are reactivated, and normal operation resumes, provided that no further risks are detected. This dynamic adjustment between states ensures that the system continuously monitors and responds to potential hazards, maintaining a safe environment for all vehicle occupants.

In some examples, the ALL LEDs On and/or the OMS LED Only states have one or more sub-states that adjust power to the enabled LEDs such as to reduce power to the LEDs such that the enabled LEDs emit less light or increase power to the LEDs such that the enabled LEDs emit more light. For example, the system achieves this adjustment by adjusting (i.e., reducing or increasing) a current and/or a voltage supplied to the LEDs. The system may transition between these sub-states prior to transitioning between the primary states. For example, when the system is in the ALL LEDs On state, the system may transition from a full power sub-state to a reduced power sub-state to reduce an amount of power provided to the DMS LED(s) or all LEDs to reduce the amount of light emitted by the LEDs prior to transitioning to the OMS LED Only state. Similarly, when the system is in the OMS LED Only state, the system may transition to an increased power sub-state to increase an amount of power provided to OMS LED(s) to increase the amount of light emitted by the LEDs prior to transitioning to the All LEDs On state. That is, the sub-states may act as intermediate states to reduce the amount of power provided to some or all of the LEDs prior to turning off the LEDs.

The transitions between these sub-states may be governed by the same parameters that control the transitions between the primary states (e.g., the distribution of brightness within the ROI, the threshold periods of time, etc.). The system may incorporate any amount debouncing between the states and sub-states of the state machine to manage these transitions effectively. Debouncing helps to prevent rapid, unintended switching between states and sub-states, which could otherwise lead to instability or flickering of the LEDs. The amount of debouncing applied can be configured according to the specific requirements of the application or the hardware used, allowing for customization based on different operational scenarios, vehicles, or user needs.

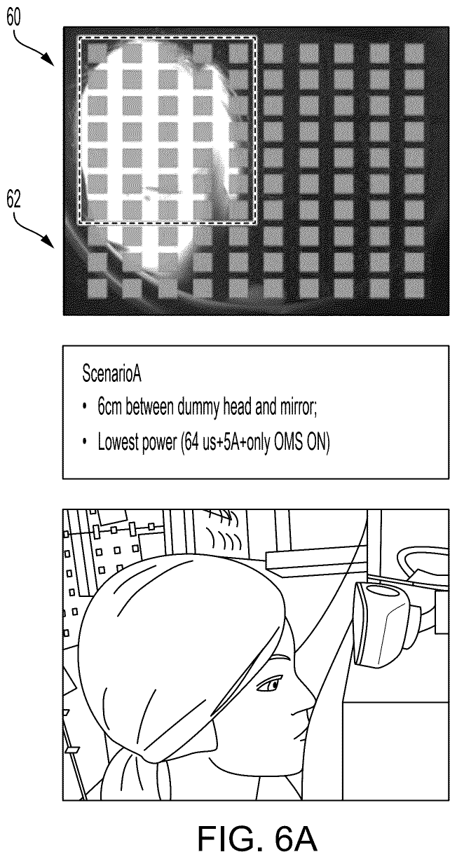

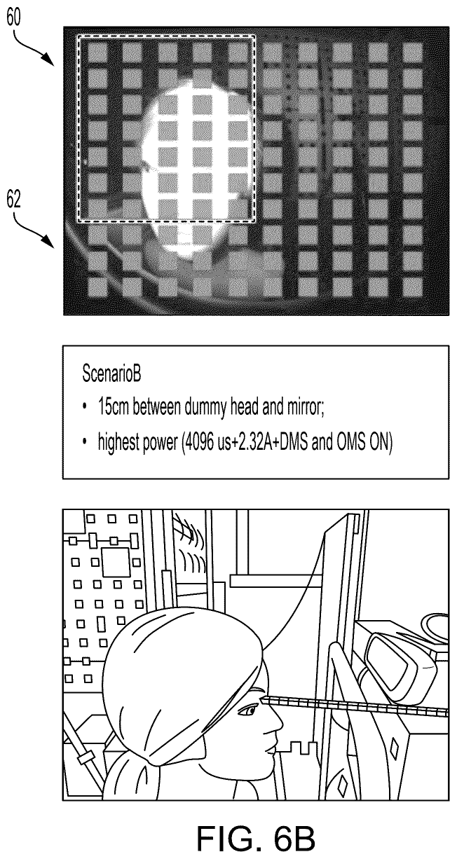

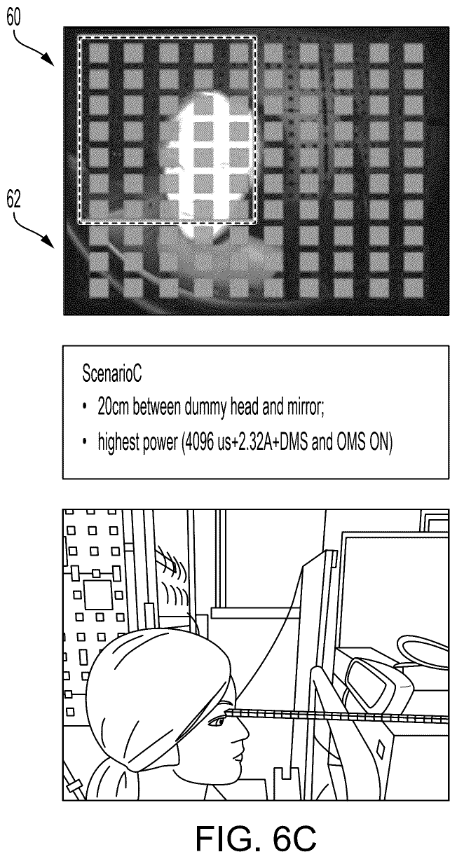

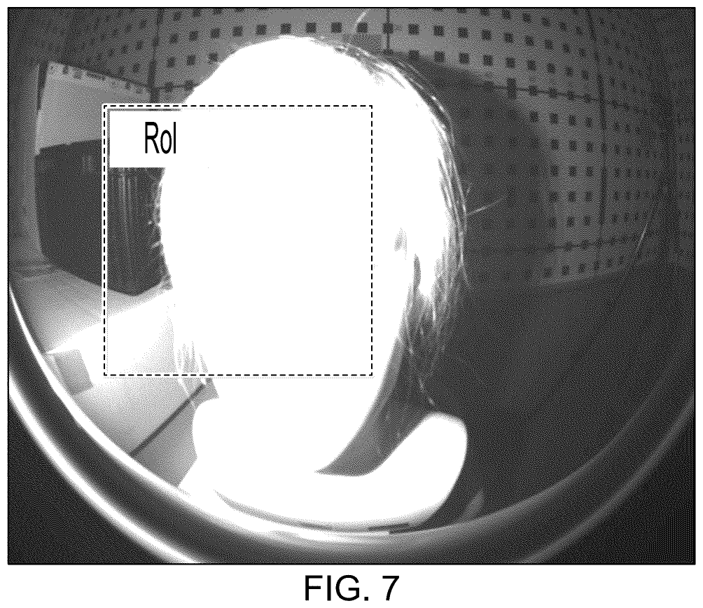

Referring now to FIGS. 6A-6C, a first scenario (FIG. 6A) is illustrated where a head is very near the LEDs (e.g., there is about 6 cm between the head and the camera). A ROI 60 (illustrated by a bounding box) surrounds a set of pixels 62 (which may represent a set of photosensors) that make up the captured image. Here, the brightness of pixels within the ROI 60 exceeds the threshold value, so the system, for example, transitions to the lowest power state with only the OMS LED enabled). In a second scenario (FIG. 6B), the head is further away from the LEDs (e.g., the head is about 15 cm from the LEDs), and the brightness of the ROI 60 has decreased to the point where the system enables both the DMS and OMS LEDs (i.e., high-power mode). In a third scenario (FIG. 6C), the head is even further away from the LEDs (e.g., the head is at least 20 cm from the LEDs) and the brightness in the ROI 60 decreases further, so the system remains in the high-power mode.

Referring now to FIG. 7, the ROI boundary may be predefined based on various factors, such as a location of the LEDs in the cabin, a location of the camera in the cabin, a location of the light emitter within the cabin, an overall size of the vehicle, a specific configuration of the vehicle (e.g., whether the vehicle is left-hand drive or right-hand drive), and the like. The ROI boundary is strategically configured to encompass a portion of the field of view of the camera where a head must be positioned when the head is in close proximity to the light emitter or LEDs. This ensures that the system can accurately capture and analyze the necessary image data to determine whether the driver or occupant is near the LEDs.

For example, as illustrated in FIG. 7, when a head is very close to the OMS and/or DMS LEDs, the head appears significantly brighter in the captured image data due to reflections from the light. Accordingly, the ROI is specifically situated in this area to effectively monitor and capture relevant data. The position of the ROI may not be static. Instead, the position may be configurable or adjusted based on any of several parameters. These parameters may include Cartesian coordinates that represent the corners of the ROI, allowing for precise customization of its location within the field of view.

Other parameters may configure other aspects, such as a parameter to configure the threshold for brightness or overexposure of a single pixel or photosensor. This ensures that only pixels or photosensors exceeding a certain brightness level are considered overexposed. Another parameter may configure the percentage of pixels within the ROI that must be overexposed to trigger a state or sub-state change. In another example, a parameter may establish an amount of debouncing, which refers to the threshold period during which pixels must remain overexposed or underexposed before a change is registered. This helps in filtering out transient changes in brightness and ensures that only consistent and significant changes are considered.

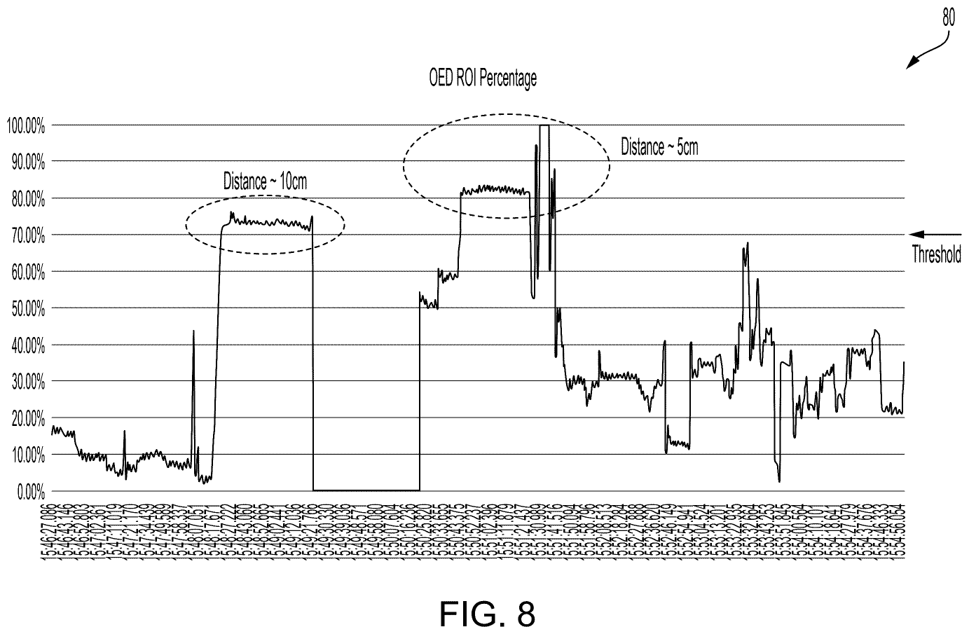

FIG. 8 includes a chart 80 plotting time along the x-axis and percentage of pixels or photosensors overexposed (based on the configurable brightness threshold) on the y-axis. In this example, the threshold percentage of pixels is 70 percent. That is, in this example, at least 70 percent of the pixels in the ROI must be overexposed to trigger a change. In the chart 80, the threshold is met when a head is 10 cm from the LEDs/camera, as the percentage of pixels that are overexposed in the ROI is about 73 percent. Additionally, when the head is 5 cm from the LEDs/camera, the percentage of pixels overexposed within the ROI grows to over 80 percent.

The size and positioning of the ROI may be configurable along with both the brightness value and the percentage of pixels within the ROI that must be overexposed based on use case and other environmental parameters of the system and vehicle. The performance of the system may be fine-tuned via careful calibration of these parameters.

Thus, implementations herein include a vehicular cabin monitoring system configured to enhance vehicle safety by monitoring the attentiveness of drivers and the presence and health of occupants. The system employs one or more cameras placed within the vehicle, such as at the rearview mirror assembly, windshield, headliner, or instrument panel, to capture images of the vehicle's interior. These images are processed to detect objects and monitor driver and occupant behavior. The system includes multiple illumination sources or light emitters, such as LEDs that emit visible or non-visible light (e.g., infrared or near-infrared light), to ensure proper illumination in low-light conditions. The light emitters may be placed at any appropriate location within the cabin of the vehicle, such as at the interior mirror assembly of the vehicle.

The system may dynamically adjust the intensity of the emitted light to prevent potential eye damage from prolonged exposure to high-intensity infrared light. For example, the system transitions between different operational states (e.g., ALL LEDs On, OMS LED Only, and ALL LEDs Off) based on the proximity of occupants to the LEDs. The system may use a state machine to manage these transitions, ensuring that the LEDs are turned off or their power is reduced when a human head is detected within a threshold distance. This approach mitigates risks associated with direct exposure to intense IR light while maintaining optimal functionality for monitoring purposes. Thus, the system detects when a human head is too close to the LEDs, which overcomes the problem in conventional solutions using blockage signals where, for example, a partial blockage results in a false negative (i.e., the system believes there is a blockage when no blockage exists and the capabilities of the system are reduced).

Optionally, the system may perform facial recognition detection and/or eye recognition detection via processing of the captured image data to determine whether a face or eyes are approaching the light emitter or illumination source. For example, the system may reduce the intensity of the near infrared light emitted by the illumination source responsive to determining that the threshold brightness level has been satisfied and responsive to determining, via processing of image data captured by the driver monitoring camera, that a person's head or face or eyes are at or near or approaching the light emitter, and the system may not reduce the intensity of the near infrared light emitted by the illumination source when the system determines that a person's hand or other object is approaching the light emitter, regardless of the determined brightness. In other words, the system may reduce the intensity of the light emitter when the system (i) determines approach of a person's face toward the light emitter and (ii) determines that the brightness of light reflecting off the person's face is greater than a threshold level, which is indicative of the person's face/eyes being within a threshold distance to the light emitter. The system may not reduce the intensity of the light emitter when the system determines approach of an object that is not a person's face toward the light emitter.

In some examples, the cabin monitoring system or occupant monitoring system may include a plurality of cameras disposed at different positions within the interior cabin of the vehicle and viewing different regions or portions of the cabin. Each of the interior-viewing cameras may include or be associated with one or more respective near IR light emitters that illuminate the respective regions of the cabin. The image data captured by each camera may be processed to determine whether the driver and/or one or more passengers of the vehicle are too close to that particular camera and its associated near IR light emitter and thus whether the intensity of light emitted by the associated near IR light emitters should be reduced or the light emitter should be deactivated, such as according to the examples discussed above. Further, image data captured by one or more of the cameras may be processed to determine proximity of the driver and/or passengers to a different camera and its associated near IR emitter and operation of that associated near IR emitter may be adjusted based on the determined proximity of the vehicle occupant to that near IR emitter.

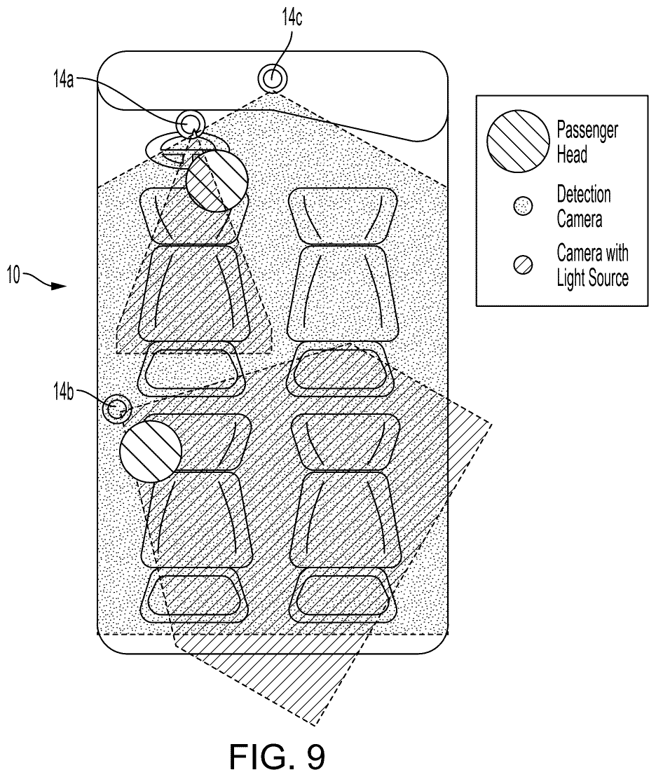

For example, and in reference to FIGS. 9-12C, the vehicle 10 includes a driver monitoring camera 14a that views at least the driver's head region within the interior cabin of the vehicle and captures image data for the DMS (e.g., to determine driver drowsiness and/or perform driver eye tracking). The driver monitoring camera 14a may be disposed at or behind the gauge cluster, the steering wheel, the vehicle dashboard and the like and includes one or more near IR light emitters at or near the camera 14a and operable to emit near IR light to illuminate the driver's head region. Further, the vehicle 10 includes an occupant monitoring camera 14b that views at least an occupant region within the interior cabin of the vehicle (e.g., one or more second row seating positions or a front passenger seating position) and captures image data for the OMS (e.g., to determine presence of occupants and/or presence of objects). The occupant monitoring camera 14b may be disposed remote from the driver monitoring camera 14a, such as at or behind a headliner, a grab handle module, a reading light module, a dome light and the like and includes one or more near IR light emitters at or near the camera 14b and operable to emit near IR light to illuminate the occupant regions. Moreover, the vehicle 10 includes a cabin monitoring or detection camera 14c that views a region or portion of the interior cabin of the vehicle that at least partially includes the driver monitoring camera 14a, the occupant monitoring camera 14b, the near IR light emitters, the driver head region and/or the occupant region. The cabin monitoring camera 14c may be disposed at a central location within the vehicle and remote from the driver monitoring camera 14a and the occupant monitoring camera 14b, such as at the interior rearview mirror assembly or an overhead console module.

Image data captured by the driver monitoring camera 14a, the occupant monitoring camera 14b and the cabin monitoring camera 14c may be transferred to the ECU 18 for processing. Optionally, controllers may be associated with each of the driver monitoring camera 14a and the occupant monitoring camera 14b (e.g., for processing image data for the DMS/OMS functions and for adjusting operation of the associated near IR light emitters) and another controller may be associated with the cabin monitoring camera 14c. Image data captured by the cabin monitoring camera 14c may be processed to determine positions of the driver and/or occupants relative to the driver monitoring camera 14a, the occupant monitoring camera 14b and associated light emitters. That is, a distance between the driver and/or occupant and the driver monitoring camera 14a or occupant monitoring camera 14b may be determined based on processing of the image data captured by the cabin monitoring camera 14c. Optionally, the image data captured by the driver monitoring camera 14a or occupant monitoring camera 14b may be processed together with and/or based on processing of the image data captured by the cabin monitoring camera 14c, such as to calibrate the determined brightness levels in the ROI of image data captured by the driver monitoring camera 14a or occupant monitoring camera 14b based on the distance between the driver and/or occupant and cameras determined based on the image data captured by the cabin monitoring camera 14c.

In other words, a plurality of cameras are disposed within the interior cabin of the vehicle 10, where at least one DMS/OMS camera controls infrared light sources and applies the overexposure detection process. Further, at least one cabin monitoring camera records the proximity of the DMS/OMS cameras. A computing device processes the cabin monitoring camera data to localize the position of all passengers in the vehicle. A computing resource may combine the input of the DMS/OMS cameras and the cabin monitoring camera.

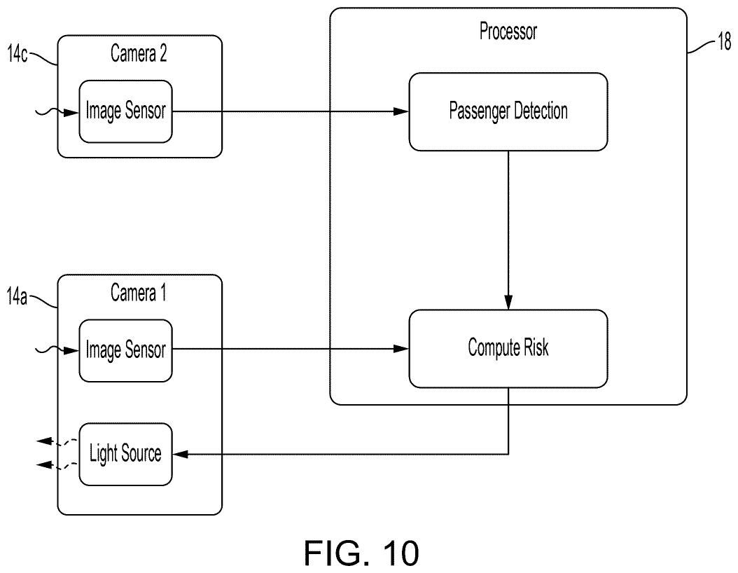

As shown in FIG. 10, the ECU 18 may receive image data captured by the cabin monitoring camera 14c and process the image data to detect the driver and/or passengers within the cabin of the vehicle 10. Optionally, the system may determine the relative position of the occupants to the driver monitoring camera 14a and/or occupant monitoring camera 14b and associated near IR light emitters based on the image data captured by the cabin monitoring camera 14c. Based on processing at the ECU 18 of image data captured by the driver monitoring camera 14a and/or occupant monitoring camera 14b, the system may determine the risk of overexposure to the near IR light posed to the vehicle occupants. Instructions or controls signals may be transferred to the camera modules for adjusting operation of the near IR light emitters based on determination of proximity of the vehicle occupant to the near IR light emitter and/or determination of near IR luminance at the vehicle occupant.

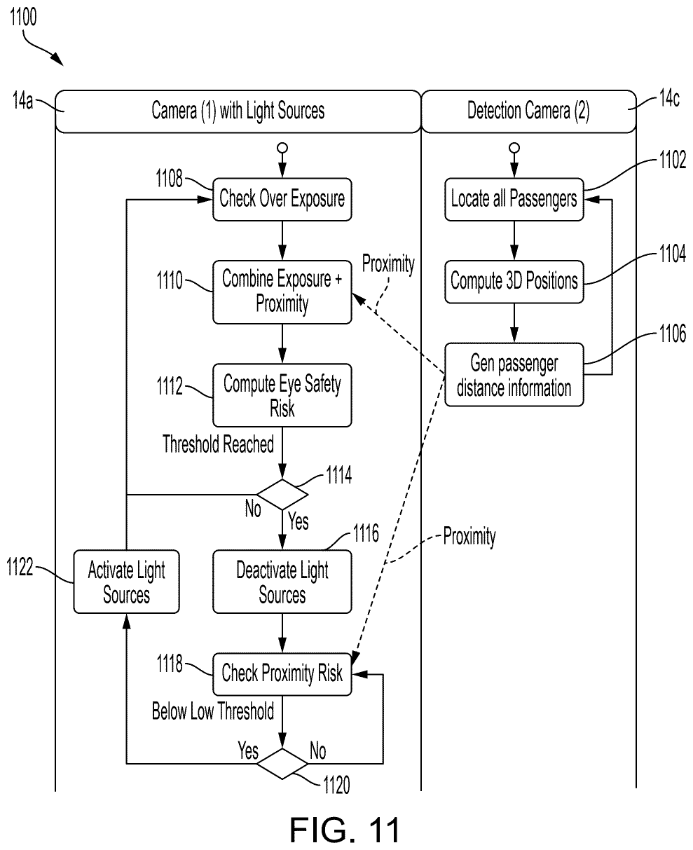

FIG. 11 is a flowchart of example operations for a method 1100 for adjusting operation of the near IR light emitters based on image data captured by the cabin monitoring camera 14c and the driver monitoring camera 14a and/or occupant monitoring camera 14b. At operation 1102, the method 1100 includes processing image data captured by the cabin monitoring camera 14c to determine presence of the driver and/or occupants within the vehicle 10. At operation 1104, the method 1100 includes determining three dimensional (3D) positions of the driver and/or occupants within the vehicle and optionally determining 3D positions of the other cameras and near IR light emitters within the vehicle. In some examples, the positions of the driver monitoring camera 14a and the occupant monitoring camera 14b may be known and the system may determine the positions of the driver and/or occupants relative to the driver monitoring camera 14a and its associated near-IR light emitter, the occupant monitoring camera 14b and its associated near-IR light emitter, and/or the cabin monitoring camera 14c and its associated near-IR light emitter. At operation 1106, the method 1100 includes determining a distance between each vehicle occupant and one or more of the cameras and/or near IR light emitters. That is, the cabin monitoring camera 14c is monitoring the vehicle interior and the proximity of the driver monitoring camera 14a and/or occupant monitoring camera 14b is visible to the cabin monitoring camera 14c. An algorithm computes the 3D position of the passengers within the vehicle. As discussed further below, the positions of the passengers may be transferred to the eye safety computing system.

At operation 1108, the method 1100 includes processing image data captured by the driver monitoring camera 14a and/or the occupant monitoring camera 14b to determine over exposure of the driver and/or occupants to near IR light. At operation 1110, the method 1100 includes combining exposure determination with the determined proximity of the occupants to the near IR light emitters based on image data from the cabin monitoring camera 14c. For example, the near IR light exposure threshold (e.g., the threshold percentage of pixels or photosensors that are overexposed) may be reduced based on determination that the vehicle occupant is close to the near IR light emitter (e.g., a distance of 10 centimeters or less, 5 centimeters or less, 2 centimeters or less and the like). At operation 1112, the method 1100 includes determining eye safety risk for the driver and/or occupant near the near IR light emitter.

At operation 1114, the method 1100 includes determining if the overexposure threshold is satisfied, such as whether greater than a threshold percentage of pixels or photosensors in the ROI are overexposed. Based on determining that the threshold is not satisfied, the method 1100 may return to operation 1108. Based on determining that the threshold is satisfied, the method 1100 includes deactivating the near IR light emitters at operation 1116. Optionally, operation 1116 may include adjusting operation of the near IR light emitters to reduce the near IR light exposure, such as adjusting the near IR light emitters from the ALL LEDs On state to the OMS LED Only state or to the All LEDs Off state. At operation 1118, the method 1100 includes determining a proximity risk of the driver and/or occupant relative to the near IR light emitter based on the position of the driver and/or occupant determined from the image data captured by the cabin monitoring camera 14c. At operation 1120, the method 1100 includes determining if the driver and/or occupant is less than a threshold distance from the near IR light emitter (e.g., 10 centimeters or less, 15 centimeters or less and the like). Based on determining that the driver and/or occupant is less than the threshold distance from the near IR light emitter, the method 1100 returns to operation 1120. Based on determining that the driver and/or occupant is greater than the threshold distance from the near IR light emitter, the method 1100 includes activating the near IR light emitters at operation 1122. For example, the system may adjust the near IR light emitters from the ALL LEDs Off state to the OMS LED Only state or to the All LEDs On state.

In other words, image data captured by the driver monitoring camera 14a and/or occupant monitoring camera 14b is processed to determine the eye safety risk for the driver and/or occupants. The eye safety risk is determined based on the rate of over-exposure in the camera image and the determined position of the driver and/or occupants relative to the near IR light emitter. If a passenger is close to the camera, then the threshold rate of over-exposure for switching into an eye-safety mode may be reduced or lowered.

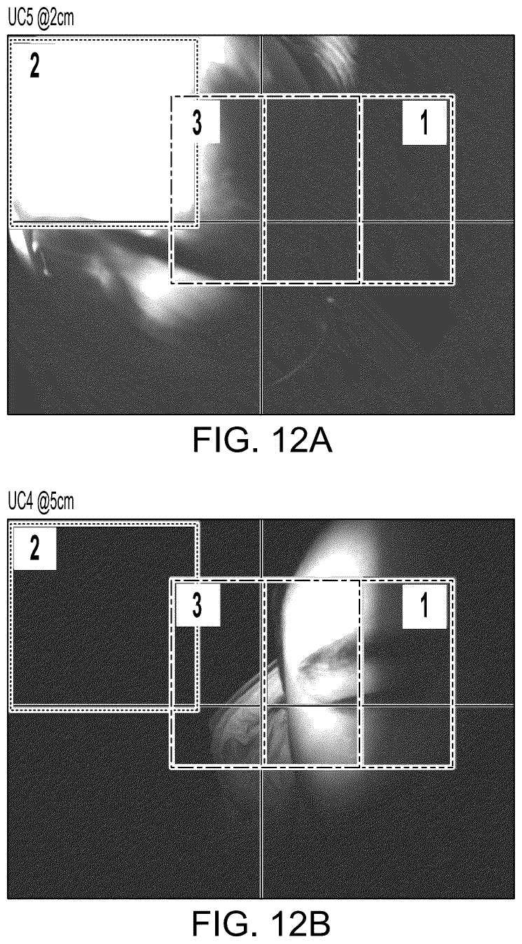

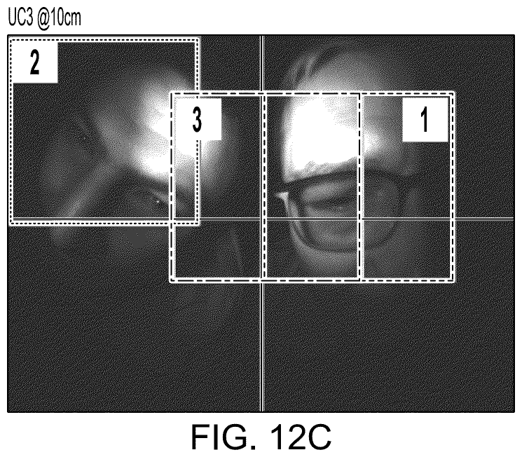

FIGS. 12A-12C depict three misuse cases where the driver and/or occupant position their head within the threshold distance of the near IR light emitter. The frames of image data captured by the driver monitoring camera 14a are processed to determine over-exposure for the driver and/or occupant. The image data is processed to detect over-exposure at three or more ROIs. In FIG. 12A, the image data may be representative of the driver and/or occupant being about 2 centimeters from the camera and/or near IR light emitter. In FIG. 12B, the image data may be representative of the driver and/or occupant being about 5 centimeters from the camera and/or near IR light emitter. In FIG. 12C, the image data may be representative of the driver and/or occupant being about 10 centimeters from the camera and/or near IR light emitter.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 19/290,465, filed Aug. 5, 2025 (Attorney Docket DON01 P5440), and/or International Publication No. WO 2023/220222 and/or International Patent Application Ser. No. PCT/US25/27206, filed May 1, 2025 (Attorney Docket MAG04 FP5372WO) and/or International Patent Application No. PCT/US25/038021, filed Jul. 17, 2025 (Attorney Docket MAG04 FP5398WO), which are all hereby incorporated herein by reference in their entireties.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Publication Nos. US 2010-0020170 and/or US-2009-0244361, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:
a first camera disposed at a first position within an interior cabin of a vehicle equipped with the vehicular cabin monitoring system, wherein the first camera views a first region within the interior cabin of the vehicle, and wherein the first camera is operable to capture image data;
a second camera disposed at a second position within the interior cabin of the vehicle spaced from the first position, wherein the second camera views a second region within the interior cabin of the vehicle different from the first region, and wherein the second camera is operable to capture image data;
wherein the first region within the interior cabin of the vehicle comprises at least a driver's head region within the interior cabin of the vehicle, and wherein the second region within the interior cabin of the vehicle comprises at least a driver region within the interior cabin of the vehicle and a passenger region within the interior cabin of the vehicle;
wherein the first camera and the second camera each comprises a respective imager, and wherein each imager comprises an imaging array having at least one million photosensors arranged in rows and columns;
an electronic control unit (ECU);
wherein image data captured by the first camera is transferred to the ECU, and wherein image data captured by the second camera is transferred to the ECU;
wherein the ECU comprises electronic circuitry and associated software, and wherein the electronic circuitry includes an image processor operable to process (i) image data captured by the first camera and transferred to the ECU and (ii) image data captured by the second camera and transferred to the ECU;
a light emitter disposed within the interior cabin of the vehicle, wherein the light emitter is operable to emit near infrared light, and wherein near infrared light emitted by the light emitter, when electrically operated to emit near infrared light, at least partially illuminates the first region within the interior cabin that is viewed by the first camera;
wherein the vehicular cabin monitoring system, at least in part via processing at the ECU of image data captured by the second camera and transferred to the ECU, detects an occupant within the interior cabin of the vehicle;
wherein the vehicular cabin monitoring system, at least in part via processing at the ECU of image data captured by the second camera and transferred to the ECU, determines a distance between the light emitter and the detected occupant within the interior cabin of the vehicle;
wherein the vehicular cabin monitoring system, when the light emitter is electrically operated to emit near infrared light, and at least in part via processing at the ECU of image data captured by the first camera and transferred to the ECU, determines luminance of near infrared light within the illuminated first region within the interior cabin that is viewed by the first camera;
wherein the vehicular cabin monitoring system, responsive to determining that luminance of near infrared light within the illuminated first region is greater than a threshold luminance, reduces intensity of near infrared light emitted by the light emitter; and
wherein, based at least in part on the determined distance between the light emitter and the detected occupant within the interior cabin of the vehicle being greater than a threshold distance, the threshold luminance comprises a first value, and wherein, based at least in part on the determined distance between the light emitter and the detected occupant within the interior cabin of the vehicle being less than the threshold distance, the threshold luminance comprises a second value that is less than the first value.

2. The vehicular cabin monitoring system of claim 1, wherein the light emitter comprises a plurality of light sources.

3. The vehicular cabin monitoring system of claim 2, wherein a first light source of the plurality of light sources, when electrically operated to emit near infrared light, emits near infrared light for driver monitoring, and wherein a second light source of the plurality of light sources, when electrically operated to emit near infrared light, emits near infrared light for occupant detection, and wherein the first light source and the second light source are separate and distinct from one another.

4. The vehicular cabin monitoring system of claim 3, wherein the vehicular cabin monitoring system reduces intensity of near infrared light emitted by the plurality of light sources by disabling the first light source for driver monitoring and not disabling the second light source for occupant detection.

5. The vehicular cabin monitoring system of claim 4, wherein the vehicular cabin monitoring system, while the first light source is disabled and responsive to determining that luminance of near infrared light within the illuminated first region is greater than the threshold luminance for a threshold period of time, disables the second light source for occupant detection.

6. The vehicular cabin monitoring system of claim 2, wherein the vehicular cabin monitoring system reduces intensity of near infrared light emitted by the plurality of light sources via one selected from the group consisting of (i) adjusting power applied to at least one light source of the plurality of light sources and (ii) not powering at least one light source of the plurality of light sources.

7. The vehicular cabin monitoring system of claim 2, wherein the plurality of light sources comprises one selected from the group consisting of (i) a plurality of vertical cavity surface emitting lasers (VCSELs) and (ii) a plurality of light emitting diodes (LEDs).

8. The vehicular cabin monitoring system of claim 1, wherein, after reducing intensity of near infrared light emitted by the light emitter, and responsive to determining that luminance of near infrared light within the illuminated first region continues to be greater than the threshold luminance for at least a threshold period of time, the vehicular cabin monitoring system disables the light emitter.

9. The vehicular cabin monitoring system of claim 1, wherein the vehicular cabin monitoring system determines that luminance of near infrared light within the illuminated first region within the interior cabin is greater than the threshold luminance based on determination that luminance of near infrared light at a region of interest of the image data captured by the first camera is greater than the threshold luminance.

10. The vehicular cabin monitoring system of claim 9, wherein the region of interest is based on location of the light emitter relative to the first camera.

11. The vehicular cabin monitoring system of claim 9, wherein the vehicular cabin monitoring system determines that luminance of near infrared light at the region of interest is greater than the threshold luminance based on determining that at least a threshold percentage of photosensors sensing the region of interest have a respective brightness value that is greater than a threshold photosensor brightness.

12. The vehicular cabin monitoring system of claim 9, wherein the region of interest is determined, at least in part via processing at the ECU of image data captured by the first camera and transferred to the ECU, to include the eyes of the occupant within the interior cabin of the vehicle.

13. The vehicular cabin monitoring system of claim 1, wherein the first camera is disposed at a mirror head of an interior rearview mirror assembly, and wherein the first camera is movable together and in tandem with the mirror head when a driver of the vehicle adjusts the rearward view provided by a mirror reflective element of the interior rearview mirror assembly, and wherein the light emitter is disposed at the mirror head.

14. The vehicular cabin monitoring system of claim 1, wherein the second camera is disposed at one selected from the group consisting of (i) an overhead console module of the vehicle and (ii) a mirror head of an interior rearview mirror assembly of the vehicle.

15. A vehicular cabin monitoring system, the vehicular cabin monitoring system comprising:
a first camera disposed at a first position within an interior cabin of a vehicle equipped with the vehicular cabin monitoring system, wherein the first camera views a first region within the interior cabin of the vehicle, and wherein the first camera is operable to capture image data;
wherein the first camera is disposed at a mirror head of an interior rearview mirror assembly, and wherein the first camera is movable together and in tandem with the mirror head when a driver of the vehicle adjusts the rearward view provided by a mirror reflective element of the interior rearview mirror assembly;
a second camera disposed at a second position within the interior cabin of the vehicle spaced from the first position, wherein the second camera views a second region within the interior cabin of the vehicle different from the first region, and wherein the second camera is operable to capture image data;
wherein the first region within the interior cabin of the vehicle comprises at least a driver's head region within the interior cabin of the vehicle, and wherein the second region within the interior cabin of the vehicle comprises at least a driver region within the interior cabin of the vehicle and a passenger region within the interior cabin of the vehicle;
wherein the first camera and the second camera each comprises a respective imager, and wherein each imager comprises an imaging array having at least one million photosensors arranged in rows and columns;
an electronic control unit (ECU);
wherein image data captured by the first camera is transferred to the ECU, and wherein image data captured by the second camera is transferred to the ECU;
wherein the ECU comprises electronic circuitry and associated software, and wherein the electronic circuitry includes an image processor operable to process (i) image data captured by the first camera and transferred to the ECU and (ii) image data captured by the second camera and transferred to the ECU;
a plurality of light emitters disposed at the mirror head, wherein the plurality of light emitters are operable to emit near infrared light, and wherein near infrared light emitted by the plurality of light emitters, when electrically operated to emit near infrared light, at least partially illuminates the first region within the interior cabin that is viewed by the first camera;
wherein a first light emitter of the plurality of light emitters, when electrically operated to emit near infrared light, emits near infrared light for driver monitoring, and wherein a second light emitter of the plurality of light emitters, when electrically operated to emit near infrared light, emits near infrared light for occupant detection, and wherein the first light emitter and the second light emitter are separate and distinct from one another;
wherein the vehicular cabin monitoring system, at least in part via processing at the ECU of image data captured by the second camera and transferred to the ECU, detects an occupant within the interior cabin of the vehicle;
wherein the vehicular cabin monitoring system, at least in part via processing at the ECU of image data captured by the second camera and transferred to the ECU, determines a distance between the plurality of light emitters and the detected occupant within the interior cabin of the vehicle;
wherein the vehicular cabin monitoring system, when the plurality of light emitters are electrically operated to emit near infrared light, and at least in part via processing at the ECU of image data captured by the first camera and transferred to the ECU, determines luminance of near infrared light within the illuminated first region within the interior cabin that is viewed by the first camera;
wherein the vehicular cabin monitoring system, responsive to determining that luminance of near infrared light is greater than a threshold luminance, reduces intensity of near infrared light emitted by the plurality of light emitters; and
wherein, based at least in part on the determined distance between the plurality of light emitters and the detected occupant within the interior cabin of the vehicle being greater than a threshold distance, the threshold luminance comprises a first value, and wherein, based at least in part on the determined distance between the plurality of light emitters and the detected occupant within the interior cabin of the vehicle being less than the threshold distance, the threshold luminance comprises a second value that is less than the first value.

16. The vehicular cabin monitoring system of claim 15, wherein the vehicular cabin monitoring system reduces intensity of near infrared light emitted by the plurality of light emitters by disabling the first light emitter for driver monitoring and not disabling the second light emitter for occupant detection.

17. The vehicular cabin monitoring system of claim 15, wherein the vehicular cabin monitoring system reduces intensity of near infrared light emitted by the plurality of light emitters via one selected from the group consisting of (i) adjusting power applied to at least one light emitter of the plurality of light emitters and (ii) not powering at least one light emitter of the plurality of light emitters.

18. A vehicular cabin monitoring system, the vehicular cabin monitoring system comprising:
a first camera disposed at a first position within an interior cabin of a vehicle equipped with the vehicular cabin monitoring system, wherein the first camera views a first region within the interior cabin of the vehicle, and wherein the first camera is operable to capture image data;
wherein the first camera is disposed at a mirror head of an interior rearview mirror assembly, and wherein the first camera is movable together and in tandem with the mirror head when a driver of the vehicle adjusts the rearward view provided by a mirror reflective element of the interior rearview mirror assembly;
a second camera disposed at a second position within the interior cabin of the vehicle spaced from the first position, wherein the second camera views a second region within the interior cabin of the vehicle different from the first region, and wherein the second camera is operable to capture image data;
wherein the first region within the interior cabin of the vehicle comprises at least a driver's head region within the interior cabin of the vehicle, and wherein the second region within the interior cabin of the vehicle comprises at least a driver region within the interior cabin of the vehicle and a passenger region within the interior cabin of the vehicle;
wherein the first camera and the second camera each comprises a respective imager, and wherein each imager comprises an imaging array having at least one million photosensors arranged in rows and columns;
an electronic control unit (ECU);
wherein image data captured by the first camera is transferred to the ECU, and wherein image data captured by the second camera is transferred to the ECU;
wherein the ECU comprises electronic circuitry and associated software, and wherein the electronic circuitry includes an image processor operable to process (i) image data captured by the first camera and transferred to the ECU and (ii) image data captured by the second camera and transferred to the ECU;
a light emitter disposed at the mirror head, wherein the light emitter is operable to emit near infrared light, and wherein near infrared light emitted by the light emitter, when electrically operated to emit near infrared light, at least partially illuminates the first region within the interior cabin that is viewed by the first camera;
wherein the vehicular cabin monitoring system, at least in part via processing at the ECU of image data captured by the second camera and transferred to the ECU, detects an occupant within the interior cabin of the vehicle;
wherein the vehicular cabin monitoring system, at least in part via processing at the ECU of image data captured by the second camera and transferred to the ECU, determines a distance between the light emitter and the detected occupant within the interior cabin of the vehicle;
wherein the vehicular cabin monitoring system, when the light emitter is electrically operated to emit near infrared light, and at least in part via processing at the ECU of image data captured by the first camera and transferred to the ECU, determines luminance of near infrared light within the illuminated first region within the interior cabin that is viewed by the first camera;
wherein the vehicular cabin monitoring system, responsive to determining that luminance of near infrared light is greater than a threshold luminance, reduces intensity of near infrared light emitted by the light emitter;
wherein the vehicular cabin monitoring system determines that luminance of near infrared light within the illuminated first region within the interior cabin is greater than the threshold luminance based on determination that luminance of near infrared light at a region of interest of the image data captured by the first camera is greater than the threshold luminance;
wherein, based at least in part on the determined distance between the light emitter and the detected occupant within the interior cabin of the vehicle being greater than a threshold distance, the threshold luminance comprises a first value, and wherein, based at least in part on the determined distance between the light emitter and the detected occupant within the interior cabin of the vehicle being less than the threshold distance, the threshold luminance comprises a second value that is less than the first value; and
wherein, after reducing intensity of near infrared light emitted by the light emitter, and responsive to determining that luminance of near infrared light at the region of interest continues to be greater than the threshold luminance for at least a threshold period of time, the vehicular cabin monitoring system disables the light emitter.

19. The vehicular cabin monitoring system of claim 18, wherein the vehicular cabin monitoring system determines that luminance of near infrared light at the region of interest is greater than the threshold luminance based on determining that at least a threshold percentage of photosensors sensing the region of interest have a respective brightness value that is greater than a threshold photosensor brightness.

20. The vehicular cabin monitoring system of claim 18, wherein the region of interest is determined, at least in part via processing at the ECU of image data captured by the first camera and transferred to the ECU, to include the eyes of the occupant within the interior cabin of the vehicle.
